(19) United States
(12) Patent Application Publication
(10) Pub. No.: US 2018/0268587 A1
(43) Pub. Date: Sep. 20, 2018

(54) DYNAMIC AD HOC GENERATION OF CUSTOMIZABLE IMAGE-BASED FILES ON COMPUTING DEVICE DISPLAYS OVER INTERACTIVE DATA NETWORKS

(71) Applicant: Google LLC, Mountain View, CA (US)

(72) Inventors: Kyler Blue, Kirkland, WA (US); Jeffrey Sinckler, San Mateo, CA (US); Zach Batteer, Mill Valley, CA (US); David McIntosh, Del Mar, CA (US); Erick Hachenburg, Menlo Park, CA (US); Andrew DeClerck, San Francisco, CA (US)

(21) Appl. No.: 15/951,794

(22) Filed: Apr. 12, 2018

Related U.S. Application Data
(62) Division of application No. 15/260,296, filed on Sep. 8, 2016.

(51) Int. Cl. G06T 11/60; H04L 12/58

(52) U.S. Cl. CPC G06T 11/60; G06T 2210/22; G06T 2200/24; G06F 3/04845; H04L 51/10

(57) ABSTRACT

Techniques for dynamic ad hoc generation of customizable image-based files on computing device displays over interactive data networks are described, including detecting an input associated with an image, the input including data associated with one or more attributes of the image, generating an overlay configured to be at least partially transparent when visually rendered over the image, producing a file using the one or more attributes, the file including other data associated with the image, the overlay, and formatting and programmatic instructions configured to visually render the image and the overlay when another input is detected, and detecting the another input associated with placement of a visual rendering of the file and the overlay, the placement being disposed within a display window associated with an application or operating system configured, at least partially, to provide an electronic data communication function between two or more computing devices in data communication with each other in substantially real-time over a distributed data network.

### CROSS-REFERENCE TO RELATED APPLICATIONS

This application is a divisional application of U.S. patent application Ser. No. 15/260,296, filed on Sep. 8, 2016, and titled “DYNAMIC AD HOC GENERATION OF CUSTOMIZABLE IMAGE-BASED FILES ON COMPUTING DEVICE DISPLAYS OVER INTERACTIVE DATA NETWORKS,” which is herein incorporated by reference in its entirety for all purposes.

### FIELD

Various embodiments relate generally to electrical and electronic hardware, computer software, software applications, wired and wireless network communications, and distributed software applications. More specifically, techniques for dynamic ad hoc generation of customizable image-based files on computing device displays over interactive data networks are described.

### BACKGROUND

Conventional techniques for transmitting and receiving electronic messages in various forms and formats are often limited to specific data communication protocols and, more specifically, often to application-limited forms of expression such as basic character text, character-constrained text messages, electronic mail messages that are limited in attachment size, and written forms of expression. The use of still or animated messages to convey simple communication messages between a sender and a recipient often are limited based on the types of devices used as well as the types, formats, and mechanisms by which data is communicated, displayed, presented, and perceived by a recipient. Given such limitations, the ability to convey messages of various import, impact, and emotion are limited in form and level of customization.

In some conventional techniques, communication between users of mobile devices often are limited and typically rely on SMS, IRC, or other basic data communication protocols and formats in order to send and receive simple, limited messages over data networks using interactive data applications. Internet or mobile device users may exchange messages through conventional media. However, some conventional techniques permit the transfer of certain types of media content, such as GIFs (Graphics Interchange Format), PNGs (Portable Network Graphics), JPEGs (Joint Photographic Experts Group), MPEGs (Moving Picture Experts Group), or other conventional still or animated data formats that may include one or more static images and/or animated images. Conventional applications often seek commercial success for sending or receiving messages using various types of content and are typically adopted based on the level of adoption of these techniques. However, conventional techniques are not well suited to providing customization of certain types of content, which limits the adoption of conventional techniques for data display and messaging. Commercial success of application developers and development organizations (e.g., software development, social networking companies) typically rely upon user adoption of applications that implement messaging techniques for various types of data formats in creative techniques. In some conventional techniques, GIFs can be transmitted as messages, but often are limited in format and effectiveness. While conventional approaches are functional, they are also not well suited to customizing images, still or animated, prior to an image being sent as a message.

Thus, what is needed is a solution for generating customized visual or graphical communication media without the limitations of conventional techniques.

### BRIEF DESCRIPTION OF THE DRAWINGS

Various embodiments or examples (“examples”) of the invention are disclosed in the following detailed description and the accompanying drawings:

FIG. 1 depicts exemplary techniques of a high-level block diagram of dynamic sticker generation, according to an embodiment;

FIG. 2 depicts exemplary techniques of a high-level block diagram of a process of selecting an image in a dynamic keyboard interface, according to an embodiment;

FIG. 3 depicts exemplary techniques of a high-level block diagram of a process of dynamic sticker generation from an image selected in a dynamic keyboard interface, according to an embodiment;

FIG. 4 depicts another example of a high-level block diagram of a process of dynamic sticker generation from an image selected in a dynamic keyboard interface, according to an embodiment;

FIG. 5 depicts an example of determining edge rate expansion of an edge of a perimeter, according to an embodiment;

FIG. 6 depicts another example of determining edge rate expansion of an edge of a perimeter, according to an embodiment;

FIG. 7 depicts exemplary techniques of flowchart of a process for generating a sticker, according to an embodiment;

FIGS. 8A and 8B depict examples of editing a sticker using a dynamic sticker generator, according to an embodiment;

FIGS. 9A and 9B depict examples of editing a sticker using a dynamic sticker generator according to an embodiment;

FIG. 10A depicts exemplary techniques of flowchart of a process for editing a sticker, according to an embodiment;

FIG. 10B illustrates an alternative exemplary process for dynamic ad hoc generation of customizable image-based files on computing device displays over interactive data networks; and

FIG. 11 depicts an exemplary computing platform disposed in a device configured to generate, edit, store and view a sticker in accordance with various embodiments.

Although the above-described drawings depict various examples of the present application, the present application is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

Communicating with other people in the Internet age has never been easier. People may communicate through various messaging platforms, including, but not limited to, SMS, iMessage, social networking or messaging systems and applications such as Facebook®, Twitter®, Snapchat®, Instagram®, WeChat®, LINE®, and the like. While text messaging remains a popular method of electronic communication, image and visual-based messaging applications, platforms and techniques offer improved communication capabilities using techniques such as those described below. Image and visual-based messaging can be used to convey more than text-based messages, but are often constrained in their ability to convey emotional overtones, context, mood, or feelings, largely due to text-based media. As described herein, the conveyance of image or visual-based content (e.g., still images, video images, moving images, or animated images) can be performed using “sticker”-based techniques, such as those described below. In some examples, a web browser may be opened on a user's computing device (i.e., “user device” or “computing device”), such as a mobile phone, smartphone, tablet, notebook, or the like, and using a computer program, software, or application to search for an image or visually-based pictorial content item, such as an animated GIF (Graphical Interchange Format) content item. Examples of formats for rendering, generating, formatting, or creating, pictorial content (e.g., content item, image content) may include, but are not limited to .gif, .jpg, .png, animated .png, .tiff, .mpeg, .mp4, .mov, or the like, including other file formats or container formats. In some examples, after identifying and selecting an image or visual content item, the communicating user can copy and paste the content item into a desired messaging platform to be displayed on a user's computing device and, if sent to another user using a messaging application such as those described above, to be rendered once received at a recipient user's computing device. The content item and placement or positioning within a messaging application window or display can be used to convey significant content, meaning, emotion, and/or context beyond the visual perception of the content item itself. Thus, the described techniques herein may describe various processes for enabling “pasted” (i.e., placement) content to appear to be substantially similar in visual perception at the destination (i.e., receiving computing device) as that of the source (i.e., sending computing device) of the pictorial content, thus preventing modification of the content item and fulfilling the intended visual expression of the sending user's computing device.

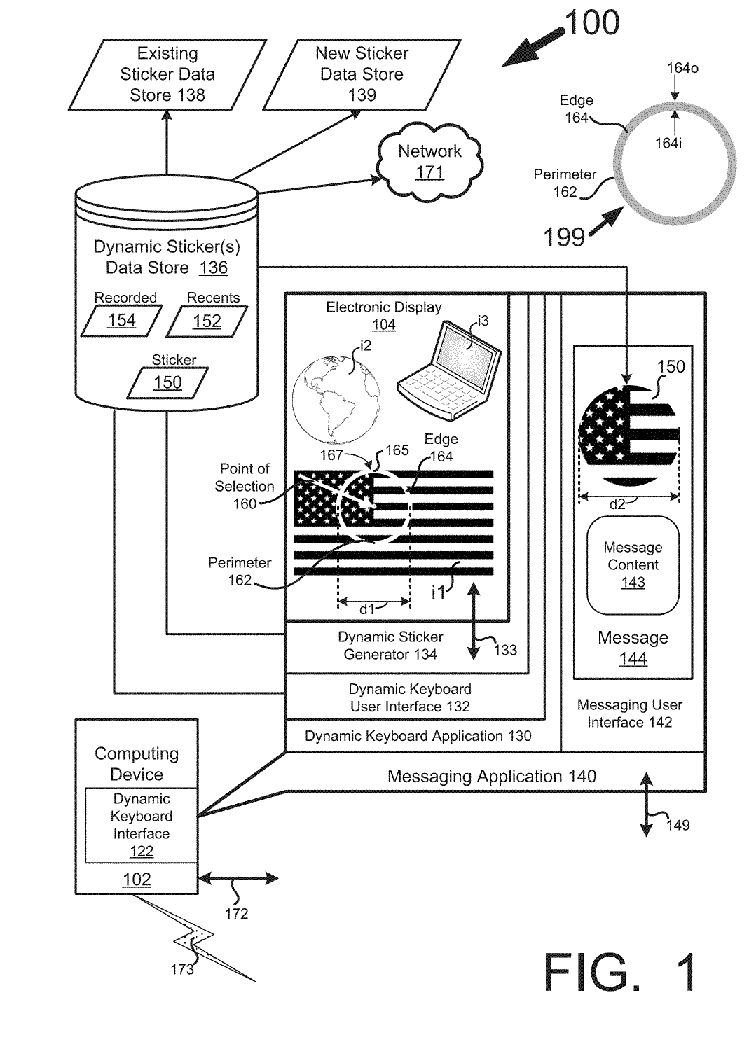

FIG. 1 depicts exemplary techniques of a high-level block diagram of dynamic sticker generation, according to some embodiments. As used herein, “sticker” may refer to any type, format, or instance of a file having data that, once processed, may be used to render, format, and/or display a static or animated image (e.g., .gif, .png, .jpg., .mov, and others) that is customizable in appearance, style, format (e.g., still vs. animated), and shape as well as placement within a display such as a “window,” panel, bar, or other area or element within a graphical user interface on any type of user interactive computing device, including, without limitation, a mobile computing device, laptop, desktop, notebook, smart phone, cellphone, or other type of interactive network-based or standalone computing device. As used herein, “sticker” may also be a term that is used generally to the ad hoc, random, deliberate, planned, and/or intended placement of user-edited or generated content within a display associated with a messaging application, the latter of which is further described in greater detail below.

Referring back to FIG. 1, block diagram 100 may be a general architecture used to describe a system that, once implemented, is configured to include computing device 102. Examples of the computing device 102 may include but are not limited to a mobile computing device, a wearable computing device, a smartphone, a smartwatch, a pad, a tablet, a touchscreen computer, a personal computer, a laptop computer, a server, a client device, and a gaming device, etc., just to name a few. The computing device 102 may include one or more processors (not shown) being configured (e.g., via an operating system and/or application software embodied in a non-transitory computer readable medium) to implement one or more functions associated with dynamic sticker generation. As further depicted in FIG. 1, a dynamic keyboard interface 122 may be implemented on the computing device 102 through a dynamic keyboard application 130 installed on the computing device 102. The dynamic keyboard interface 122 may be implemented on an electronic display 104 of the computing device 102. For example, the electronic display 104 may constitute a touch screen display being configured to visually display data (e.g., graphical data including formatting or programmatic computer code (e.g., object, source, or the like) that, once processed, parsed, or otherwise used in threaded computations or algorithms, may be used to represent visually perceptible information conveyed from a sending user(s) to recipient user(s)) associated with the dynamic keyboard interface 122. Digital or analog types of data representing the visually perceptible information (image content or image hereinafter) may include, but is not limited to, text (e.g., ASCII), graphics, live images from an image capture device, GIFs (Graphics Interchange Format), PNGs (Portable Network Graphics), JPEGs (Joint Photographic Experts Group), MPEGs (Moving Picture Experts Group), a multimedia container file format (e.g., .MOV or .MP4), or one or more other formats for image files that may include one or more static images and/or animated images. In some examples, image content being displayed on the electronic display 104 (display 104 hereinafter) may include one or more portions of the image content that are animated (e.g. in motion).

In some examples, a dynamic keyboard application 130 may install a dynamic keyboard user interface 132 that enables the dynamic keyboard interface 122 to be accessed throughout the computing device 102 as a third-party keyboard. In this way, a messaging user using a messaging application 140, such as electronic text messaging, electronic mail (i.e., “email”) messaging, Internet Relay Chat (i.e., IRC), “chat” messaging, and other applications, without limitation, may access dynamic keyboard interface 122 using one or more control signals (e.g., digital data signals transmitted to/from) messaging application 140.

Here, dynamic sticker generator 134 may be implemented as a module comprised of computer program, application, software, firmware, or circuitry, or other program instructions or logic that, once processed, are used by dynamic keyboard user interface 132 top initiate the generation of a “sticker” (as described above) and configured to be in data communication with display 104. The dynamic sticker generator 134 may be configured to dynamically capture image content being displayed on the display and generate, based on the image content, a new image that is an edited version of the image content. The edited version of the image content may constitute a customized illustration or animation of the image content being displayed on the display 104 (e.g., a customized sticker, a sticker dynamically generated on the fly from the image content, or others). For example, image content may constitute an image of an American flag i1, a globe i2, and laptop computer i3. In some examples, image content may reside in a data repository or in a memory (e.g., non-volatile memory) of the computing device 102, may be captured by an image capture device, or may be uploaded or otherwise accessed by the computing device 102, for example. In some examples image content may constitute a static image; whereas in other examples, image content may constitute a dynamic image (e.g., an animated image) in which one or more elements in the image are in motion. Image i1 may be selected 160 (e.g., by physical contact of a finger or a stylus to a portion of display 104 where the image i1 is being displayed). After the selection of image i1, the dynamic sticker generator 134 may display a visually perceptible image of a perimeter 162 having a visually perceptible closed geometric shape. The perimeter 162 may be configured to visually overlay the portion of the image i1. The perimeter 162 may include an edge 164 being configured to visually indicate the closed geometric shape of the perimeter 162. In example 199, the perimeter 162 (depicted in gray) may include the edge 164 having an inside edge 164i and an outside edge 164o. For example, the perimeter 162 may visually serve as a tool (e.g., a cropping image) to visually crop the image i1 so that the visually perceptible information (e.g., in image i1) within an inside edge 164i of the edge 164 of the perimeter 162 may be selected for generation of a new image (e.g., to form a sticker based on portions if the image i1 disposed within the edge 164 of the perimeter 162). For example, the visually perceptible information in image i1 disposed outside of an outside edge 164i of the edge 164 of the perimeter 162 may be cropped out of the resulting new image (e.g., a sticker). The perimeter 162 may have a color (e.g., white, gray, gray scale, black, yellow, red, blue, green, or other color) being configured to visually contrast with the image so that the color of the perimeter 162 is visually distinct from the image (e.g., image i1) being overlaid by the perimeter 162.

In some examples, dynamic sticker generator 134 may be configured to cause the edge 164 of the perimeter 162 to expand outward from a point on the image i1 that was selected 160. During expansion of the edge 164, one or more dimensions of the perimeter 162 may be increased (e.g., an increase in radius, diameter, length, width, height, etc.). The edge 164 may be further configured to visually indicate a geometric shape of the perimeter 162. In block diagram 100, the geometric shape of the perimeter 162 is depicted as a circle. However, the geometric shape of the perimeter 162 may include other geometric shapes (e.g., squares, rectangles, polygons, triangles, ovals, arcuate shapes, complex geometric shapes, etc.) and is not limited to the circle depicted in FIG. 1. The edge 164 may continue to expand outward until the edge 164 reaches a restriction associated with the image i1. Examples of a restriction may include but is not limited to the edge 164 being substantially coincident 165 with another edge 167 of the image i1, or the image i1 no longer being selected (e.g., by disengaging the physical contact of the finger or the stylus with the portion of display 104 where image i1 is being displayed).

Here, dynamic sticker generator 134 may be configured to cause the expansion of the edge to be halted when the restriction is determined, and to generate data representing a new image 150 having visually perceptive information associated with the image i1 after the expansion is halted. The new image 150 (denoted as a sticker hereinafter). The sticker 150 may include data representing portions of the of image i1 that is substantially circumscribed by the edge 164 when the expanding of the edge 164 is halted. An image dimension d2 of the sticker 150 may be substantially identical to a dimension d1 of the perimeter 162 when the expanding of the edge 164 is halted.

In some examples, expansion of the edge 164 of the perimeter 162 may be along one or more dimensions of the geometric shape of the perimeter 162. For example, if the geometric shape of the perimeter 162 is a circle, then expansion of the edge 164 may be along a radius dimension of the circle. As another example, if the geometric shape of the perimeter 162 is a rectangle, the expansion may be along a width dimension, a height dimension, or both.

Here, sticker 150 that was generated by the dynamic sticker generator 134 may then be transmitted or copied and pasted into a messaging user interface 142 of the messaging application 140. In some examples, a selected sticker (e.g., sticker 150) may be selected by clicking, tapping, or touching an image of the selected sticker being displayed by the dynamic keyboard interface 122 and holding the selected sticker to “copy” the selected sticker so that it may be “pasted” into the messaging application 140 through the messaging user interface 142. This copy and paste method may take advantage of the operating system of the computing device 102, in some examples, such that the selected sticker is not stored permanently onto the computing device 102. In another example, a drag and drop operation may be implemented to move a sticker or a copy of a sticker (e.g., sticker 150) from a display associated with the dynamic keyboard interface 122 into the messaging application 140 through the messaging user interface 142. In at least some examples, the dynamic keyboard interface 122 may be implemented as a GIF keyboard, as produced by TENOR, INC. of San Francisco, Calif. The GIF keyboard may include image content or an image content stream that constitutes one or more GIF images and one or more sticker images, for example.

In other examples, a sticker (e.g., sticker 150) may be stored in a data repository that is included in the computing device 102, such as dynamic sticker data store 136 that may be configured to store one or more generated stickers being generated by the dynamic sticker generator 134. In yet another example, one or more generated stickers being generated by the dynamic sticker generator 134 may be stored in an existing sticker data store 138, a new sticker data store 139, a network 171 (e.g., the Cloud or the Internet), or some combination of the foregoing. Data stores 138 and/or 139 may be disposed internal to the computing device 102 or may be disposed external to the computing device 102. Data stores 138 and/or 139 may constitute a sticker pack being configured to store data representing one or more stickers. One or more stickers (e.g., sticker 150 and/or other stickers) that are generated (e.g., created using dynamic sticker generator 134), communicated or sent (e.g., by messaging application 140 via 149, 172, 173) or accessed (e.g. received from Network 171) may be stored in a “Recents” data store 152. Stickers that are created and/or edited and then saved, may be stored (using dynamic sticker generator 134) in a “Recorded” data store 154. In some examples, the “Recorded” data store 154 may constitute a recorded stickers pack.

In some examples, messaging application 140 may communicate 149 or otherwise transmit (e.g., using a wired 172 and/or a wireless 173 communication link of the computing device 102, or the over network 171), a message 144 that includes the sticker 150. In some examples, the message 144 may include message content 143 (e.g., one or more items of image content, textual content or other content) along with the sticker 150. In other examples, the sticker 150 (e.g., an instance of the sticker 150) may be instantiated or otherwise positioned anywhere within the message 144. The sticker 150 may be displayed substantially concurrently with the message content 143. As a first example, the sticker 150 may be positioned apart from the message content 143. As a second example, the sticker 150 may be positioned to overlap, overlay, or partially obscure at least a portion of the message content 143 (not shown). As a third example, the sticker 150 may be positioned to overlap, overlay, or partially obscure at least a portion of a GIF, another sticker, an icon, or other image or text included in the message content 143.

Further to FIG. 1, the computing device 102 may include circuitry, software, hardware, one or more processors, or any combination of the foregoing, to implement functionality of the dynamic keyboard interface 122, the messing application 140, the messaging user interface 142, the dynamic keyboard user interface 132, and the dynamic sticker generator 134, for example.

As an example, a processor(s) (e.g., of the computing device 102) may be configured: to detect selection 160 of a portion the image content i1 being displayed on the display 104 of the computing device 102; display the perimeter 162 being configured to visually overlay the portion of the image content i1, the perimeter 162 may including the edge 164 being configured to visually indicate a geometric shape (e.g., a circle shape) of the perimeter 162; to expand the edge 164 outward from the portion of the image content i1, the edge 164 being configured to circumscribe additional portions of the image content i1 as the edge 162 is expanding, a dimension of the perimeter 162 being increased as the edge 164 expands; to halt the expanding of the edge 164 based on the edge 164 of the perimeter 162 being substantially coincident 165 with another edge 167 being associated with the image content i1, or based on the portion of the image content i1 no longer being selected 160; to generate data representing a sticker 150, the sticker 150 including image data representing portions of the image content i1 being substantially circumscribed by the edge 164 when the expanding of the edge 164 is halted, the sticker 150 including an image dimension d2 being substantially identical to the dimension d1 of the perimeter 162 when the expanding of the edge 164 is halted; and to store the sticker 150 in a data repository 136. An operating system and/or application software embodied in a non-transitory computer readable medium may be executed by one or more computer processor(s) to implement one or more of the above described functions. In other examples, the above-described techniques may be varied and are not limited to the exemplary embodiments shown or described.

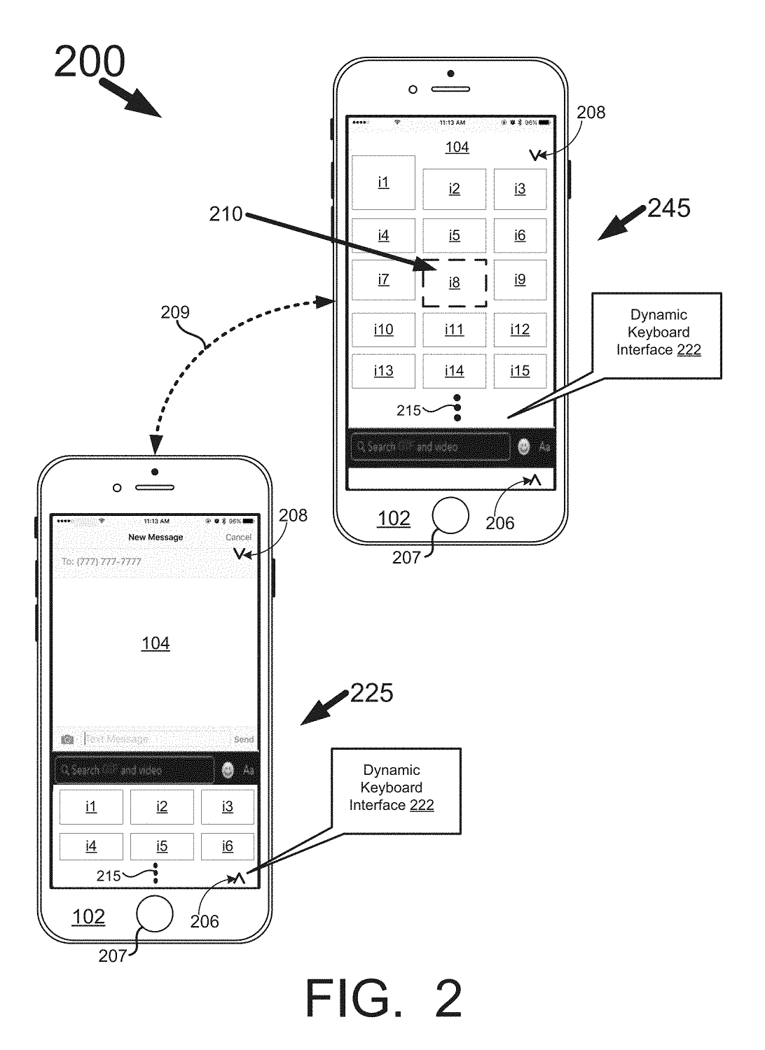

FIG. 2 depicts exemplary techniques of a high-level block diagram of a process of selecting an image in a dynamic keyboard interface, according to some embodiments. In FIG. 2, block diagram 200 may include a dynamic keyboard interface 222 being implemented on the display 104 of computing device 102. In some examples, the computing device 102 may include a biometric identification device 207 (e.g., a fingerprint or thumbprint scanner) being configured to authenticate access credentials (e.g., of a user of computing device 102) associated with a function of the dynamic keyboard application 130 of FIG. 1.

In example 225, the dynamic keyboard interface 222 may be displayed on a portion of the display 104 (e.g., a one-half screen view) where an image content stream 215 having one or more images i1-i6 may be displayed by the dynamic keyboard interface 222. There may be additional images in the image content stream 215 that may not be visible in the one-half screen view depicted in example 225. A screen expansion icon 206 may be activated (e.g., by selecting icon 206 with a finger, a stylus, a cursor or other user interface device) to cause the screen view to expand to a full-screen view depicted in example 245, where additional images i7-i15 in the image content stream 215 may displayed by the dynamic keyboard interface 222. Another icon 208 may be activated to switch the screen view back to the one-half screen view depicted in example 225. Icons 206 and 208 may be activated to switch 209 the screen view back and forth between the one-half screen view and the full screen view depicted in examples 225 and 245, for example.

In example 245, an image i8 has been selected 208 as an image source to dynamically generate a sticker (e.g., sticker 150 depicted in FIG. 1). The selected image i8 is depicted in dashed line to indicate that of the images i1-i15 being displayed by the dynamic keyboard interface 222, the image i8 is the image being selected for sticker generation. Although not depicted in example 225, one of the images i1-i6 may be selected to dynamically generate a sticker while the dynamic keyboard interface 222 is in the one-half screen view. In the one-half screen view, the full-screen view, or both, images in the image content stream 215 that are not being presently displayed on the display 104 may be brought into view on the display 104 by a scrolling action (e.g., up, down, left, right, etc.). For example, a swiping action by a finger, a stylus, a cursor or other user interface device may be used to cause scrolling on the display 104. Selection of an image in the one-half screen view or the full-screen view, in some examples, may be activated by physically touching a display screen on which is displayed an image (e.g., a portion of display 104 where image i8 is being displayed may be contacted by a finger or a stylus). In other examples, the above-described techniques may be varied and are not limited to the exemplary embodiments shown or described.

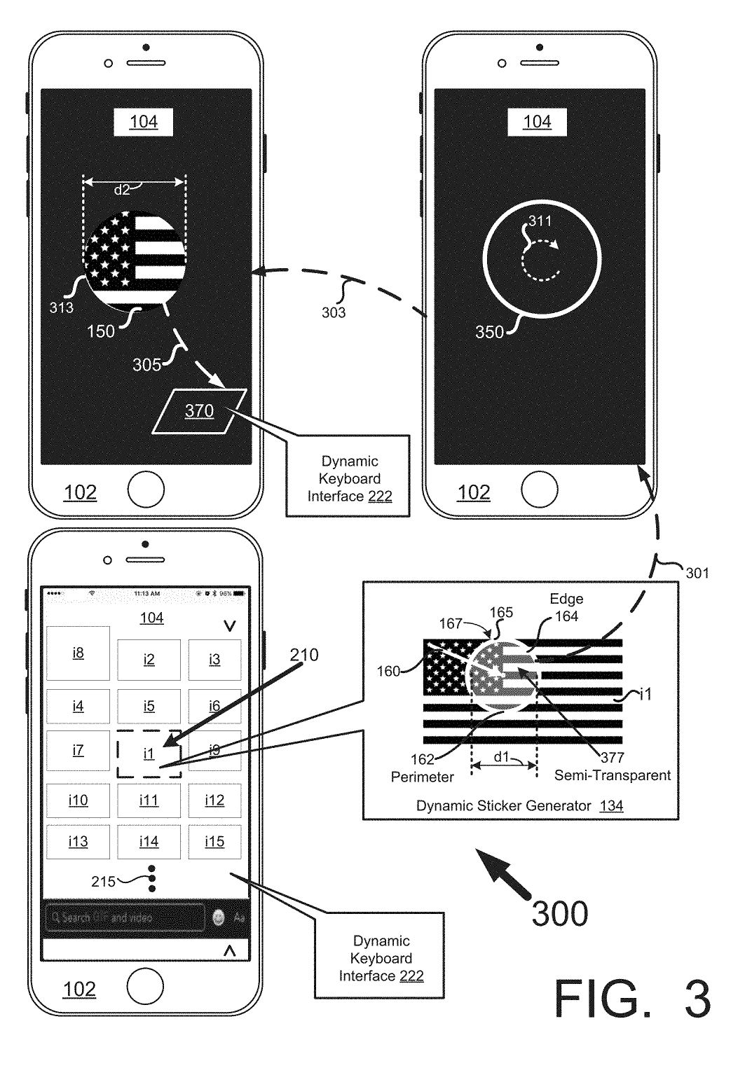

FIG. 3 depicts exemplary techniques of a high-level block diagram of a process of dynamic sticker generation from an image selected in a dynamic keyboard interface, according to some embodiments. In FIG. 3, an image content stream including image content i1 is being displayed on display 104 by dynamic keyboard interface 222. Image content i1 is selected 210 to generate a sticker, which may be all or a portion of a still or animated image such as a .gif file. In some examples, dynamic sticker generator 134 is configured to receive data representing image content i1 and is also configured to generate perimeter 162 having the edge 164 that, in some examples, expands radially outward until a desired portion of edge 164 is substantially coincident with an edge 167 of the image i1 as was described above in reference to FIG. 1. As described herein, the described techniques create an overlay or overlaid shape that can be configured to block a portion of an underlying image in order to create, for example, a sticker of a desired shape and size. The rate at which the shape and/or size of the overlay is generated can be controlled based on the detection of a user input, which may, for example, be a “long hold” or press on a display screen using interactive technologies such as capacitive touch, piezoelectric, or haptic interfaces, without limitation. In some examples, the rate of expansion can be metered or measured in, for example, pixels per second, which can be adjusted or modified to permit faster or slower shape definition. As used herein, “shape definition” may refer to the creation of an overlay that, when visually perceived, rendered, or otherwise displayed for perception by a user, appears as an expanding shape that permits increased portions of a content item to appear. In some examples, the appearance of the content item is visually rendered as such although the underlying mechanism is the adjustment in both shape and opacity (or transparency or translucency) of the overlay (i.e., overlaid image file) when placed over the “parent” desired content item. In other examples, detected input can take other forms and formats, including the detection of bio-electric (e.g., bioimpedance) signals, digital data, binary data, analog electrical signals, or others, without limitation. Once detected, a sticker is generated using processes to permit a user to engage in data communication using techniques such as those described herein. In other words, instead of sending an entire .gif, a user may wish to send only a portion of a .gif file as a sticker by pressing, touching, or otherwise providing an input that can be used to initiate and/or define the size and shape of a given sticker by controlling the rate at which the overlay expands to permit underlying content (e.g., the displayed image, video, animation, or the like) to be revealed or displayed. Once a desired overlay has been created, the overlay, with the underlying image or animation file, can be used to create a file, container, script, thread, or the like that defines the sticker and, when another input is detected, can be visually rendered or displayed at a location selected by a user, application, system, or otherwise. In other examples, the above-described techniques may be varied and are not limited to the examples shown and described.

Further to FIG. 3, in some examples, the portion of the image i1 being circumscribed by the perimeter 162 may be substantially visually semi-transparent 377 (e.g., having a transparency on display 104 ranging from about 40% to about 75%). The edge 164 of the perimeter 162 may be substantially visually opaque (e.g., white, black, grey scale or some other color or pattern of colors). The edge 164 of the perimeter 162 may be made substantially visually opaque in order to visually highlight those portions of the image i1 (e.g., the portion circumscribed by the perimeter 162) that may be included in the sticker to be generated. In other examples, the transparency 377 of the image i1 being circumscribed by the perimeter 162 may be substantially 0% (see FIG. 1).

In FIG. 3, subsequent to the portion of the image i1 being cropped within the perimeter 162, the dynamic sticker generator 134 may transition 301 to processing 350 the portion circumscribed by the perimeter 162 into a sticker. The dynamic sticker generator 134 may be configured to cause an indicator 311 to be displayed on display 104, the indicator being a visual indication that processing 350 of the sticker is in progress. When processing 350 is complete, the dynamic sticker generator 134 may transition 303 to displaying the sticker 150 on display 104. The sticker 150 may include a geometric shape 313 that is substantially identical to the geometric shape of the edge 164 of the perimeter 162. An image dimension d2 of the sticker 150 may be substantially identical to the dimension d1 of the perimeter 162 when the expanding of the edge 164 is halted.

Subsequent to the sticker 150 being generated, the dynamic sticker generator 134 may store 305 data representing the sticker 150 in a data repository 370 (e.g., a file, a data store, or data repository 136). The dynamic keyboard interface 222 may display the sticker 150 along with other stickers and/or other image content on the display 104. In other examples, the above-described techniques may be varied and are not limited to the exemplary embodiments shown or described.

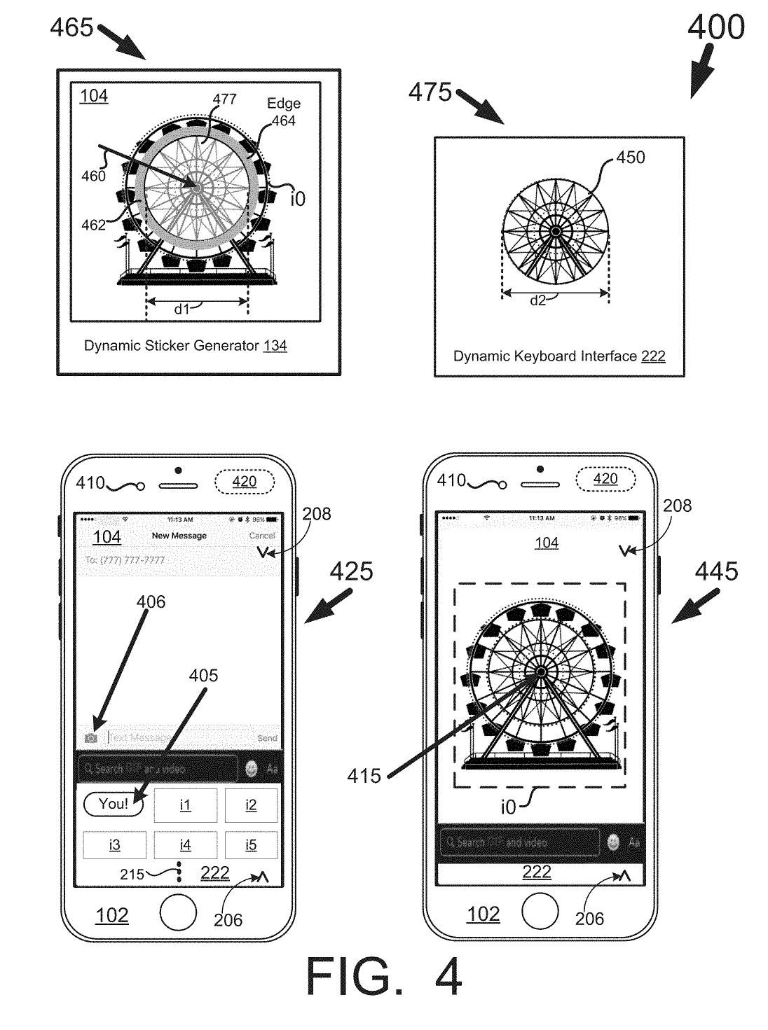

FIG. 4 depicts another example of a high-level block diagram of a process of dynamic sticker generation from an image selected in a dynamic keyboard interface, according to some embodiments. In FIG. 4, block diagram depicts in example 425, the dynamic keyboard interface 222 including an icon 405 “You!” that may be selected (e.g., using a cursor, a finger, a stylus, a touch) to enable image capture from an image capture device of the computing device 102. Selection of the icon 405 may activate a front facing image capture device 410 or a rear facing image capture device 420 being positioned on an opposite side of the computing device 102 (e.g., the front and rear facing cameras of a smartphone, tablet, or pad). Alternatively, an icon 406 may be selected to activate the front facing image capture device 410 or the rear facing image capture device 420.

In example 445, after activation of the image capture device (e.g., 410 or 420) an image i0 may be captured and presented on display 104 (e.g., presented in the full-screen view of the dynamic keyboard interface 222). The image i0 may subsequently be selected 415 and in example 456, the dynamic sticker generator 134 may be activated to process the image i0 into a sticker. As described above in reference to FIGS. 1 and 3, the dynamic sticker generator 134 may generate a perimeter 462 having an edge 464 and portions of the image i0 being circumscribed by the edge 464 may be displayed as being semi-transparent 477, for example. Further to example 465, selection 460 of the portion of the image i0 to be circumscribed by the edge 464 may be removed or otherwise disengaged to halt expansion of the edge 464 (e.g., as opposed to the edge meeting a restriction in the image i0). In example 475, a sticker 450 has been generated by the dynamic sticker generator 134 and the dynamic keyboard interface 222 may display the image of the sticker 450. A dimensions dl of the portion of the image i0 being circumscribed by the edge 464 and an image dimension d2 the sticker 450 may be substantially identical to each other. In other examples, the above-described techniques may be varied and are not limited to the exemplary embodiments shown or described.

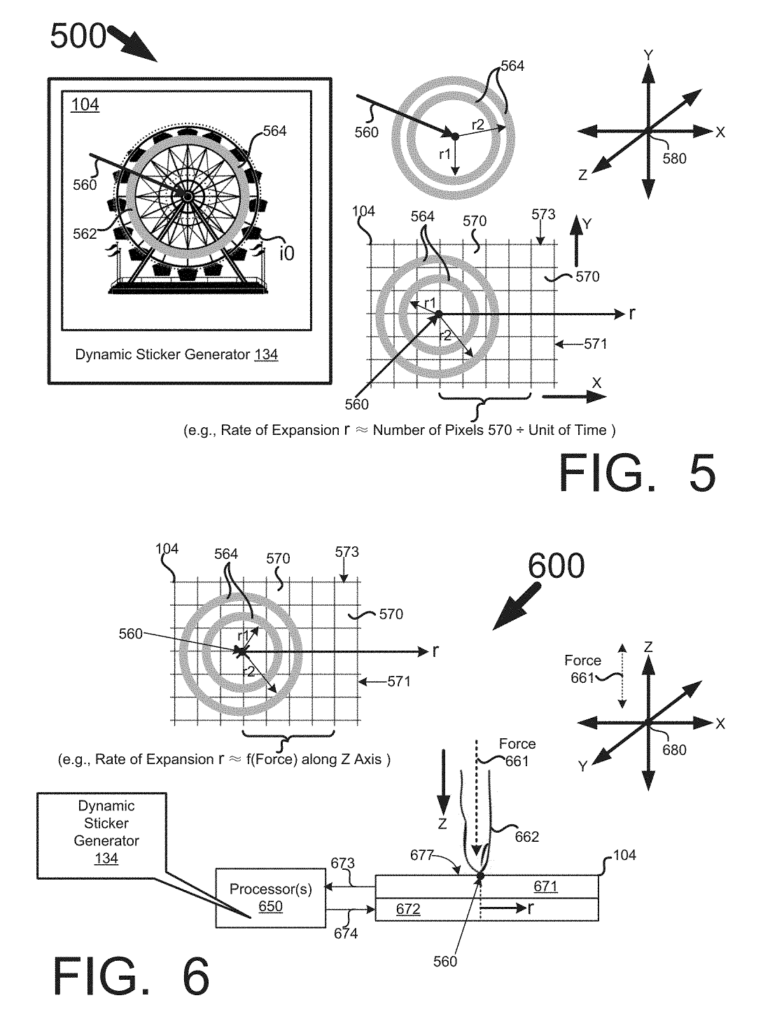

FIG. 5 depicts an example of determining edge rate expansion of an edge of a perimeter, according to some embodiments. An edge 564 of a perimeter 562 generated by the dynamic sticker generator 134 may expand outward of the point of selection 560 (e.g., from a first radial distance r1 to a second radial distance r2) in the image content i0 at a rate of expansion determined, at least in part, by the display 104.

Display 104 may include pixels 570 being arranged in rows 571 and columns 573 (e.g., in an orderly array), with the columns 573 being oriented along a Y-axis and the rows 571 being oriented along a X-axis of a coordinate system 580, for example. The point of selection 560 (e.g., a point of contact of a finger or stylus or other user interface device with a surface of the display 104) may cover one or more of the pixels 570. A rate of expansion “r” of the edge 564 (e.g., along the X-axis) may be calculated to be a number of pixels 570 divided by a unit of time. As an example, a radius of the edge 564 may increase (e.g., expand) with the rate of expansion “r” being substantially four pixels of radius per one-tenth of a second (e.g., r≈4 Pixels per 0.1 seconds). Data representing the rate of expansion “r” may be stored in memory or constitute data associated with an application that implements the dynamic sticker generator 134, for example. The data representing the rate of expansion “r” may be a constant value or may be varied via a menu, determined by a user profile, user preferences, etc., for example. The rate of expansion “r” of the edge 564 may be halted when the edge 564 reaches a restriction associated with the image i0 (e.g., another edge of the image i0) or the image content is no longer being selected 560. In other examples, the above-described techniques may be varied and are not limited to the exemplary embodiments shown or described.

FIG. 6 depicts another example of determining edge rate expansion of an edge of a perimeter, according to some embodiments. In FIG. 6, the display 104 may include a sensing layer 671 and an image layer 672. The image content i0, the perimeter 562 and other image data may be displayed by pixels 570 in the image layer 672 and contact of an object with the display 104 may be sensed by the sensor layer 671. Sensor layer 671 may be configured to sense a force 661 associated with contact of an object with a surface 677 of the sensor layer 671 (e.g., a finger 662 making contact with the surface 677 substantially at the point of selection 560 and generating a contact force). Sensor layer 671 may be configured to generate a signal 673 being indicative of the force 661 being applied to the surface 677 at the point of selection 560. A processor(s) 650 may be coupled to signal 673 and may process signal 673 to compute a rate of expansion “r” of the edge 564 that is a function of the force 661 (e.g., r≈proportional to the force 661). In FIG. 6, the force 661 is depicted as being applied substantially along a Z-axis of coordinate system 680 (e.g., the Z-axis is into the drawing sheet).

In some examples, processor(s) 650 may generate a signal 674 being coupled to the image layer 672 to cause an image associated with the edge 564 of the perimeter 562 to expand outward of the point of selection 560 substantially at the rate of expansion “r”. The dynamic sticker generator 134 may be implemented as executable program code in processor(s) 650 and the processor(s) 650 may be configured by the dynamic sticker generator 134 to determine the force 661 and compute the rate of expansion “r”. Expansion of the edge 564 outward of the point of selection 560 may be halted when the signal 673 is indicative of the force 661 (e.g., the contact force generated by finger 662) is substantially zero (e.g., force 661≈0 Newtons). In other examples, the above-described techniques may be varied and are not limited to the exemplary embodiments shown or described.

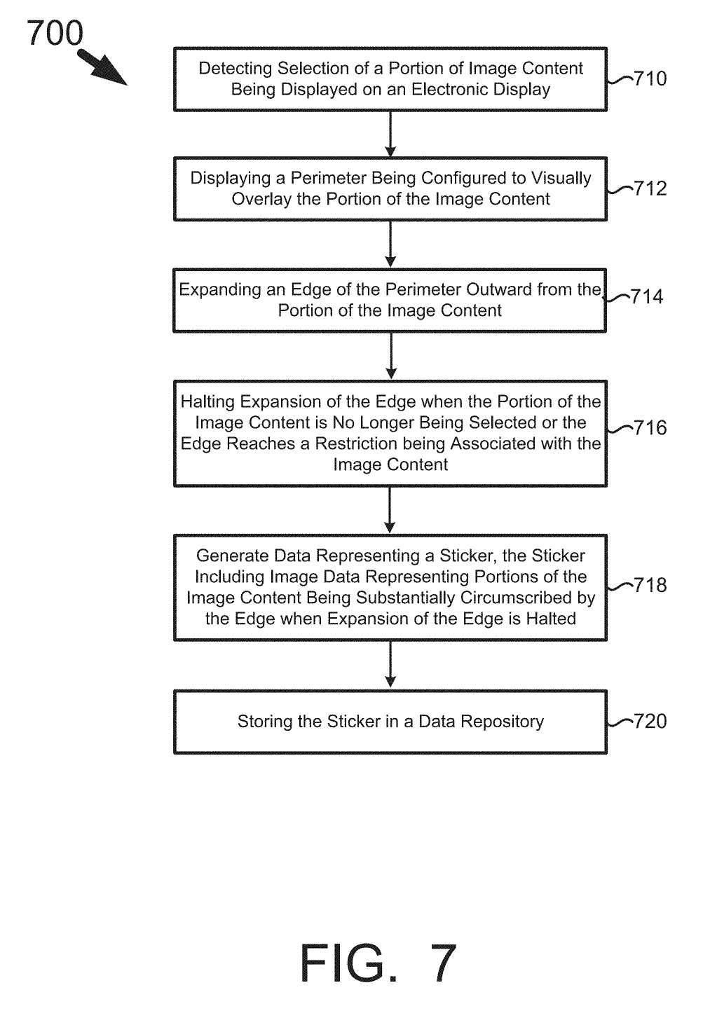

FIG. 7 depicts exemplary techniques of flowchart of a process for generating a sticker, according to an embodiment. At step 710 of flowchart 700, selection of a portion of image content (e.g., visually perceptible information) being displayed on a display (e.g., an electronic display of a computing device) may be detected. At step 712, a perimeter being configured to visually overlay the portion of the image content may be displayed on the display. At step 714, an edge of the perimeter may be expanded outward from the portion of the image content (e.g., the portion of the image content being selected at the step 710). The edge of the perimeter may be configured to visually indicate geometry of the perimeter. A dimension of the perimeter may increase during expansion of the edge. At step 716, expansion of the edge of the perimeter may be halted (e.g., limited, restricted, or otherwise stopped) when the portion of the image content is no longer being selected or when the edge reaches a restriction being associated with the image content (e.g., the edge being substantially coincident with another edge associated with the image content). At step 718, data representing a sticker may be generated. The sticker may include image data representing portions of the image content being circumscribed by the edge of the perimeter when the expansion of the edge is halted. The sticker may include a dimension that is substantially identical to the dimension of the perimeter when expansion of the edge is halted. At step 720, the sticker may be stored in a data repository (e.g., a data store, memory, non-volatile memory, the Cloud, the Internet or the like). In other examples, the above-described techniques may be varied and are not limited to the exemplary embodiments shown or described.

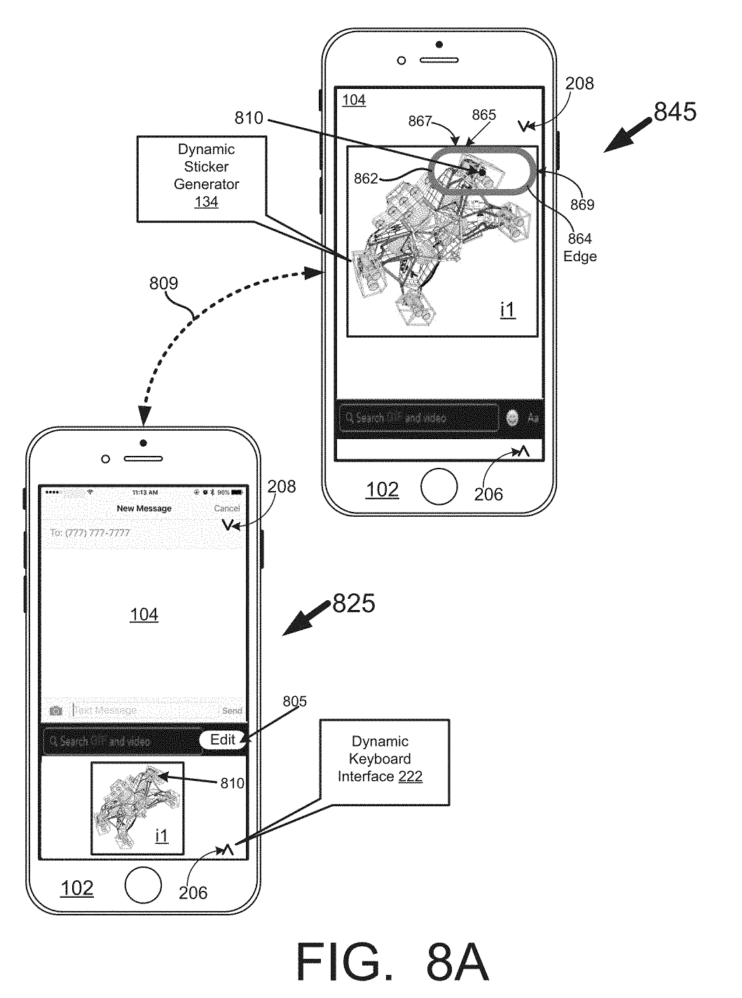

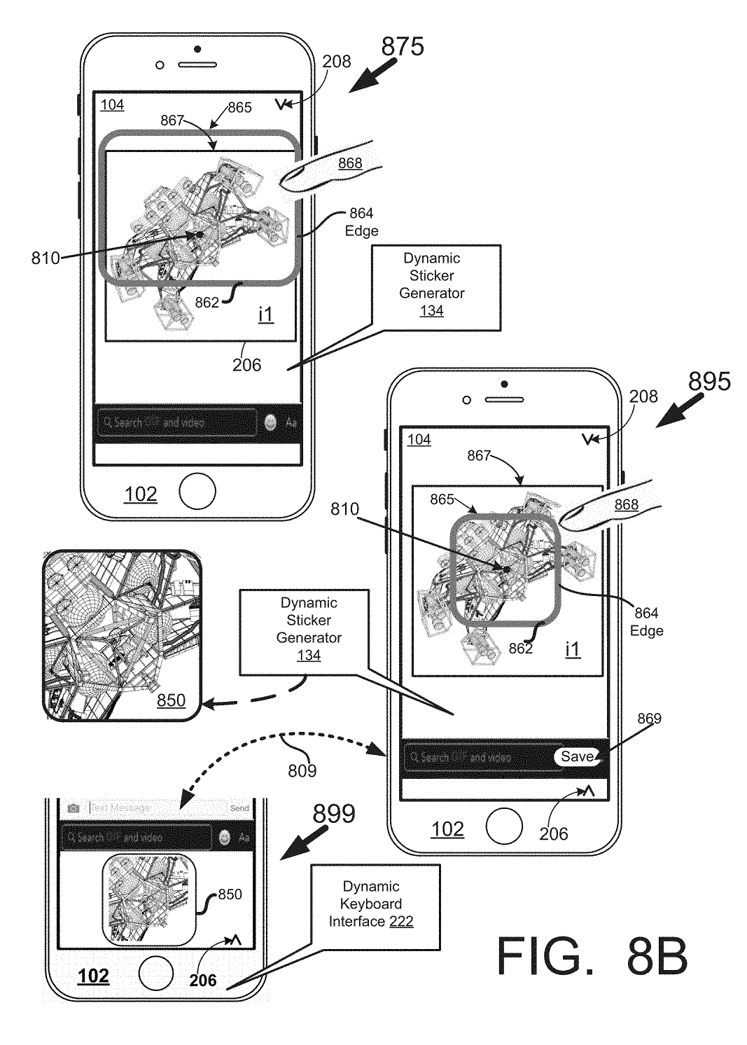

FIGS. 8A and 8B depict examples of editing a sticker using a dynamic sticker generator, according to some embodiments. In FIG. 8A, it may be desirable to edit the visual appearance of a sticker being displayed on computing device 102. In example 825 of FIG. 8A, a sticker i1 may be presented by the dynamic keyboard interface 222 on display 104 (e.g., in one-half screen view). An “Edit” icon of the dynamic keyboard interface 222 may be selected 805 to initiate editing of the sticker i1. A point 810 on sticker i1 may then be selected. To facilitate the editing process, the dynamic keyboard interface 222 may switch 809 from the one-half screen view to the full screen view where the sticker i1 may be presented in an enlarged view as depicted in example 845 of FIG. 8A. The dynamic keyboard interface 222 may activate the dynamic sticker generator 134 to enable editing of the sticker i1. The point of selection 810 on the sticker i1 may be circumscribed by a perimeter 862 (e.g., having an oval shape). In some examples, one or more edges of the perimeter 862 may reach a restriction associated with the sticker i1, such as edge 865 reaching edge 867 and edge 869 of the sticker i1.

However, to allow for flexibility in editing of the sticker i1, a position and/or a size of the perimeter 862 may be altered relative to the image of the sticker i1 and the perimeter 862 may be manipulated to extend outside of one or more edges of the sticker i1. Additionally, the point of selection 810 on the sticker i1 may be moved relative to the perimeter 862 and need not be symmetrically centered within the perimeter 862 as is depicted in example 875 of FIG. 8B. In example 875, the point of selection 810 has been repositioned on the display 104 relative to the sticker i1 (e.g., using a finger 868, stylus or other user interface) and the perimeter 862 has been enlarged and positioned relative to the edges of the sticker i1 such that the edge 864 of the perimeter 862 is positioned outside of one or more edges of the sticker i1 (e.g., edge 865 is above edge 867). In example 895 of FIG. 8B, the perimeter 862 may be repositioned and resized (e.g., using finger 868) to circumscribe an area of the sticker i1 to be included in an edited version of the sticker. In example 895, all edges of the perimeter 862 have been repositioned to be within the edges of the sticker i1. When the position of the point of selection 810 and the position and size of the perimeter 862 have been arranged to produce a desired editing result, a “Save” icon 869 may be selected and the dynamic sticker generator 134 may generate a sticker 850 that includes the desired edits. The dynamic sticker generator 134 may save the newly edited sticker 850 and the sticker 850 may be presented on the dynamic keyboard interface 222. After editing is completed, the dynamic keyboard interface 822 may switch 809 from the full screen view back the one-half screen view as is depicted in example 899.

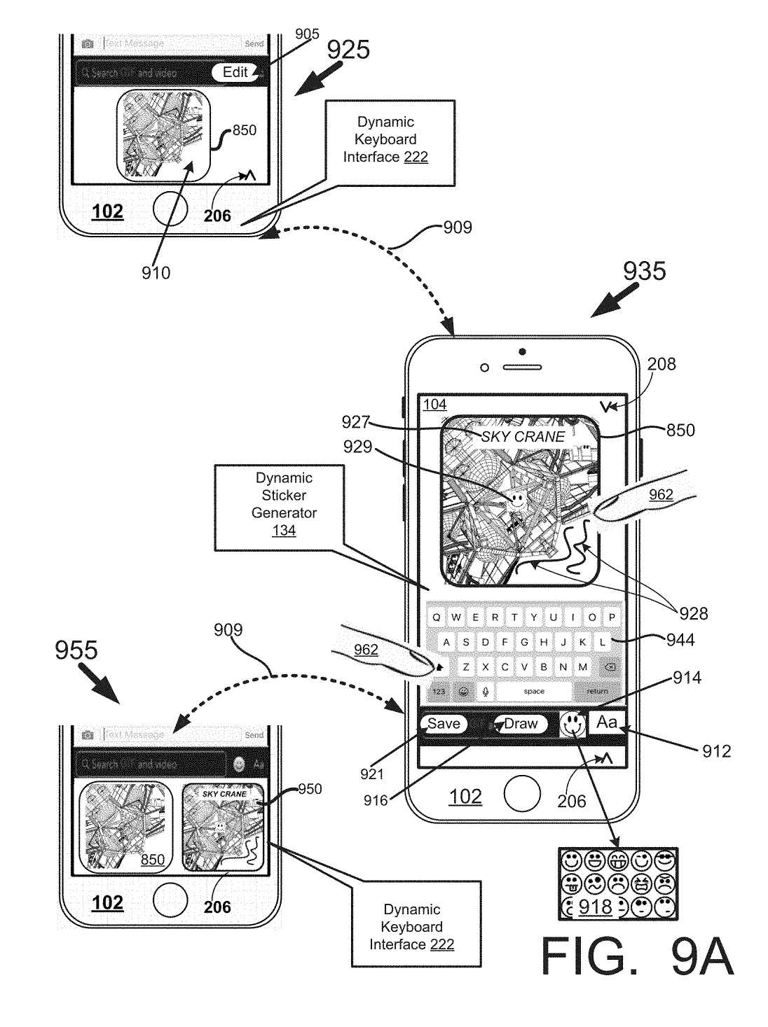

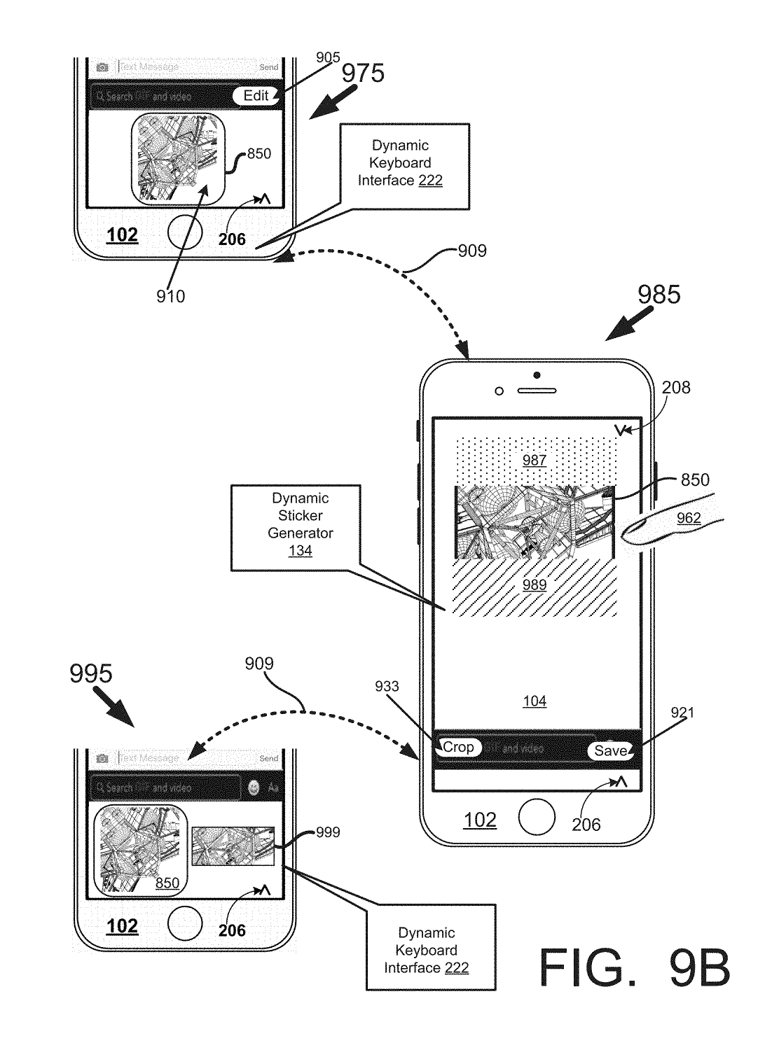

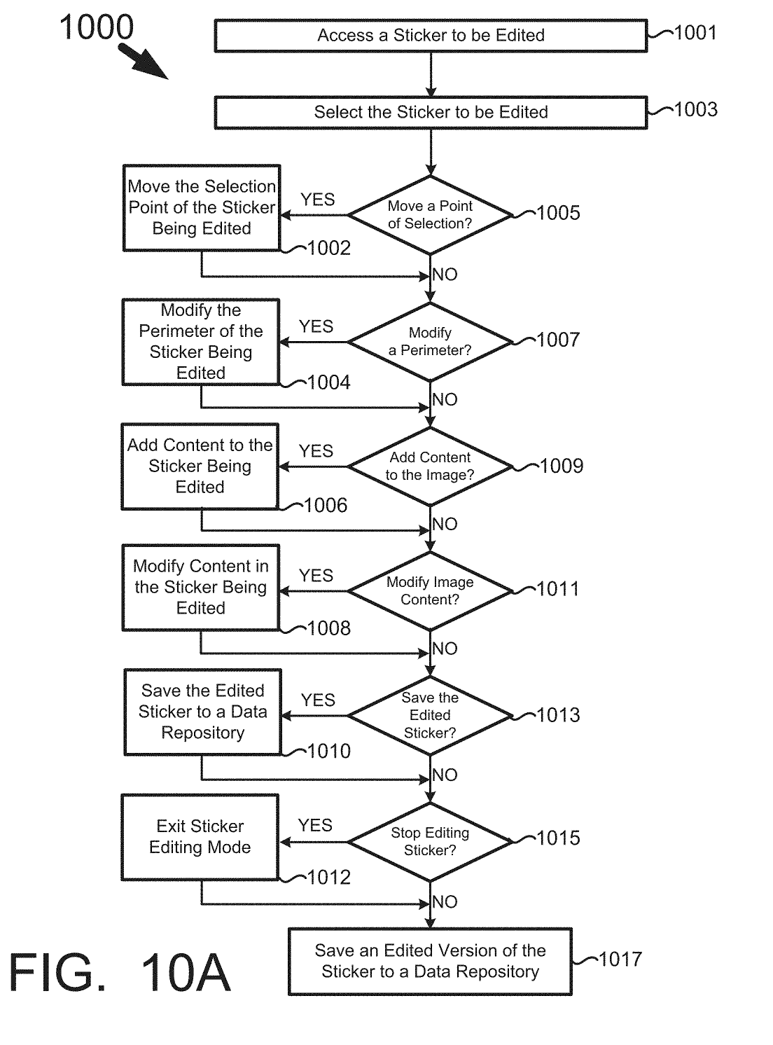

FIGS. 9A and 9B depict examples of editing a sticker using a dynamic sticker generator, according to some embodiments. In example 925 of FIG. 9A, a sticker 850 may be presented on display 104 by the dynamic keyboard interface 222 and may be selected 910 for an action, such as editing. An “Edit” icon 905 may be selected to intimate editing of the sticker 850. To provide a larger image of the sticker for editing, the dynamic keyboard interface 222 may switch 909 from the one-half screen view to the full screen view depicted in example 935 of FIG. 9A. In example 935, a larger view of the sticker 850 is presented on display 104. A keyboard icon “Aa” may be selected 912 to display a keyboard 944 to be used to add textual images or a caption to the sticker 850. An emoji icon 914 may be selected to add emoji images from a menu 918 to the sticker 850. A “Draw” icon may be selected 916 to allow for drawing on the sticker 850. Other types of editing and icons or menus may be evoked by the dynamic sticker generator 134 to edit the sticker 850 and the foregoing examples are non-limiting examples of types of edits that may be performed on a sticker.

In example 935, the keyboard 944 may be used (e.g., via finger 962) to add text 927 “SKY CRANE” (or other types of captions such as “See U Soon”) to the sticker 850. The menu 918 may be used to instantiate an emoji image 929 in the sticker 850. Selection 916 of the “Draw” icon may be used to add line images 928 to the sticker 850, for example. A “Save” icon may be selected 921 to save the edited sticker (e.g., as a new sticker 950). The edited sticker 950 may be displayed by the dynamic keyboard interface 222 along with the un-edited version of sticker 850 as depicted in example 955. After editing is completed, the dynamic keyboard interface 222 may switch 909 back to the one-half screen view depicted in example 955. In some examples, selecting 921 the “Save” icon may be used to overwrite sticker 850 with the edits added in example 935 and the edited version of sticker 850 may be displayed by the dynamic keyboard interface 222.

In example 975 of FIG. 9B, sticker 850 may be selected 910 and the “Edit” icon may be selected to initiate editing of the sticker 850. In example 985, a “Crop” icon may be selected 933 to allow one or more portions of the image of the sticker 850 to be erased, deleted, blocked out, covered up or otherwise altered to remove one or more portions of the image of the sticker 850. In example 985, patches 987 and 989 have been positioned over the image of the sticker 850 to crop out (e.g., block out) portions of the sticker 850 being covered by the patches 987 and 989. In example 995, the edited sticker 850 has been saved (e.g., by selection 921 of the “Save” icon) as a new sticker 999 in which the cropped out portions of the image have been removed. The edits to the sticker 850 may also change an aspect ratio of the sticker such that sticker 999 is presented with a different aspect ratio than sticker 850.

In some examples, stickers that have been edited may be saved to memory or some other data repository, such as an existing sticker pack, a new sticker pack created to store the edited or newly created sticker, or some other data repository. For example, selecting the “Save” icon may be configured to allow a sticker (e.g., a newly created sticker, an edited sticker) to be saved in an existing collection of stickers, such as a sticker pack for “Spacecraft” or allow for creation of a new collection or sticker pack for “SKY CRANE”, for example. The dynamic keyboard interface 222 may be configured to assign names or other designations to a sticker, a collection of stickers, a sticker pack, a data repository of stickers or other images, and a data store of stickers or other images, for example. In other examples, the above-described techniques may be varied and are not limited to the exemplary embodiments shown or described.

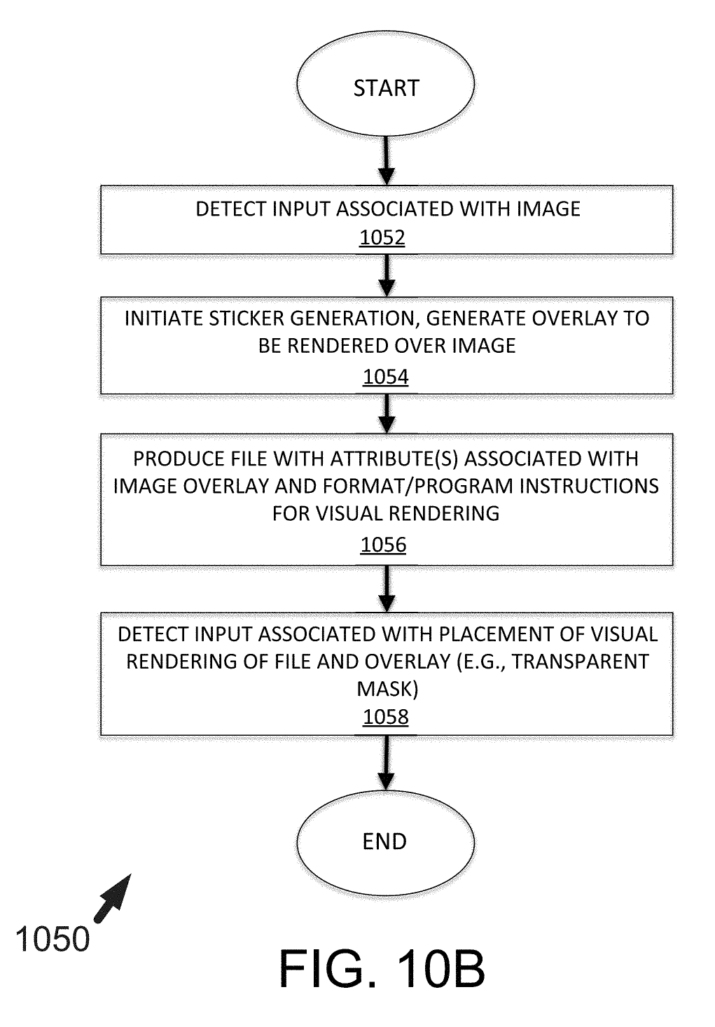

FIG. 10A depicts exemplary techniques of flowchart of a process for editing a sticker, according to some embodiments. At a step 1001 of flowchart 1000, a sticker to be edited may be accessed (e.g., by a processor from a data repository, from a network, from dynamic keyboard interface 222, dynamic sticker generator 134). At step 1003 the sticker to be edited may be selected (e.g., using a cursor, stylus, finger, or other user interface device). At a step 1005 a decision to move a selection point of on the sticker being edited may be made. As YES branch from step 1005 may transition to a step 1002 where the selection point may be moved or otherwise repositioned relative to image content of the sticker being edited. The selection point need not be symmetrically centered with a perimeter associated with the sticker being edited (e.g., the selection point need not be at the center or focus of the perimeter).

At step 1007, a determination may be made to modify a perimeter of the sticker being edited. As YES branch from step 1007 may transition to a step 1004 where the perimeter may be modified (e.g., resized, moved around relative to the image content of the sticker, moved relative to the selection point of the sticker, moved outside of one or more edges of the sticker, etc.).

At step 1009, a determination may be made to add content to the image of the sticker being edited. Added content may include but is not limited to text, a caption, a drawing, an emoji, another sticker, and another image, for example. A YES branch from step 1009 may transition to a step 1006 were content may be added to the sticker being edited.

At step 1011, a determination may be made to modify content in the image of the sticker being edited. Examples of modified content may include but are not limited to removing, blocking out, overwriting, obscuring, and deleting content in the sticker being edited. A YES branch from the step 1001 may transition to a step 1008 where content in the sticker may be modified.

At step 1013, a determination may be made to save the sticker being edited. A YES branch from the step 1013 may transition to a step 1010 where the edited sticker or a version of the edited sticker may be saved to a data repository (e.g., new sticker data store 139, existing sticker data store 138, dynamic sticker data store 136, recorded data store 154, recents data store 152 of FIG. 1). In some examples, the edited sticker may be saved to memory and may be displayed on a display by the dynamic keyboard interface 122. In other examples, an edited sticker may be saved to a sticker pack or other collection of stickers. In yet another example, an edited sticker may be communicated to an external resource (e.g., network 171 of FIG. 1).

At step 1015, a determination may be made to stop editing the sticker. A YES branch from the step 1015 may transition to a step 1012 where the sticker editing mode may be exited or otherwise terminated. Exiting the sticker editing mode may cause a transition from the dynamic sticker generator 134 back to the dynamic keyboard interface 122. The edited sticker may be displayed (e.g., on display 104) by the dynamic keyboard interface 122.

At step 1017, if NO branches are taken from the steps 1013 and 1015, then an edited version of the sticker that being edited may be stored in a data repository (e.g., recents data store 152) and the sticker that was selected for editing at the step 1003 may remain unedited. In the event a user changes his/her mind, the edited version may be retrieved from the data repository for further editing, to be saved as a new sticker, or used to overwrite/replace the sticker that was selected for editing at the step 1003, for example. In other examples, the above-described techniques may be varied and are not limited to the exemplary embodiments shown or described.

FIG. 10B illustrates an alternative exemplary process for dynamic ad hoc generation of customizable image-based files on computing device displays over interactive data networks. In some examples, process 1050 may include detecting an input associated with an image, the input including data associated with one or more attributes of the image (1052). Images, in some examples, may be still, animated, or other types or formats of visually rendered or displayed content such as .gifs, .pngs, .wav, .mov, or others, without limitation. Examples of input may include the detection of a finger press, force touch, haptic input, digital or electronic input, or any other type of input received on a computing device or a display therefor, that indicates a given image has been selected. After detecting an input, process 1050 continues by generating an overlay configured to be at least partially transparent when visually rendered over the image (1054). In some examples, an overlay may be referred to as a “transparent mask” wherein the overlay may be a shape, layer, or pixelated image intended or designed to block, obstruct, or render transparent some, all, or none of an underlying image. When overlaid on top of an image, the underlying content appears to the extent of the transparency and level of transparency permitted by the transparent mask or overlay. In other examples, portions of a displayed image or image content (e.g., such as files of the types and formats described above) may be visible in various shapes and/or sizes, using techniques such as those described above. Next, a file s produced using the one or more attributes, the file including other data associated with the image, the overlay, and formatting and programmatic instructions configured to visually render the image and the overlay when another input is detected (1056). Further, process 1050 continues by detecting the another input associated with placement of a visual rendering of the file and the overlay, the placement being disposed within a display window associated with an application or operating system configured, at least partially, to provide an electronic data communication function between two or more computing devices in data communication with each other in substantially real-time over a distributed data network (1058). In other examples, the above-described process may be varied in steps, order, functionality, features, scope, or other aspects, without limitation to those shown and described herein.

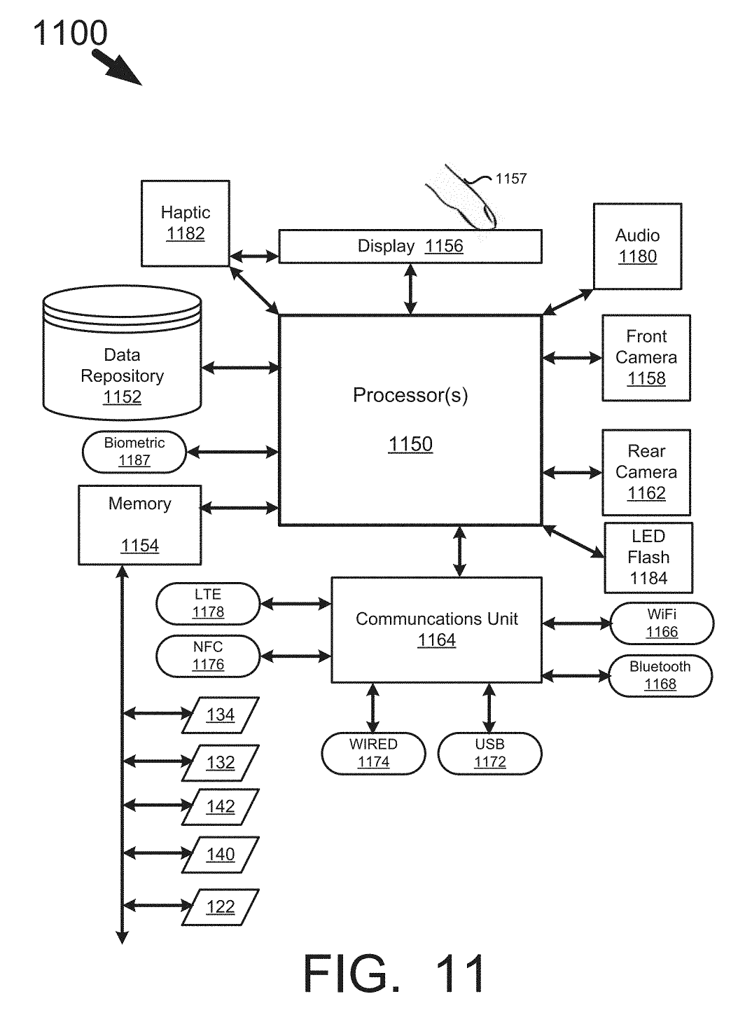

FIG. 11 depicts an exemplary computing platform disposed in a device configured to generate, edit, store and view a sticker in accordance with various embodiments. Computing platform 1100 may include one or more processors 1150 being configure to implement one or more functions of a computing device (e.g., a smartphone, tablet, pad, touch screen computer, laptop computer, server, wearable device, smartwatch, etc.). Examples of processors included but are not limited to a microprocessor, a microcontroller, a digital signal processor, a graphics processor, and a baseband processor, just to name a few. A display 1156 may be in communication with the processor 1150 and may also be in communication with a haptic unit 1182 configured to provide haptic feedback associated with use of the display 1156 by a user. Display 1156 may be a touch screen display configured to respond to touch of a finger 1157, stylus, user interface device, or the like, for example. The processor 1150 may be in communication with a front camera 1158 (e.g., for taking selfies), a rear facing camera 1162, and a LED flash configured to illuminate images to be captured by camera 1158 and/or 1162. Stickers may be generated and optionally edited based on images captured by cameras 1158 and 1162, for example. The processor 1150 may be in communication with a biometric unit 1187 being configured to use a biometric signature (e.g., a fingerprint, a thumbprint, a retina, etc.) to be used as a form of access credential to access the computing platform or a computing device or to communicate data, for example.

A communications unit 1164 may be in communication with the processor 1150 and may be in communication with a WiFi radio 1166, a Bluetooth radio 1168, a NFC radio 1176, and a cellular radio LTE 1178, for example. The communication unit 1164 may be in communication with wired communication unit 1174 (e.g., LAN, Firewire, Lightning, etc.) and a USB unit 1172.

The processor 1150 may be in communication with a data repository 1152 and a memory 1154. Memory 1154 may be configured to store algorithms, software applications, data, and an operating system, for example. The data repository 1152 and/or the memory 1154 may constitute non-volatile memory (e.g., Flash memory, solid state memory, etc.). The data repository 1152 and/or the memory 1154 may constitute non-transitory computer readable mediums that may be accessed by the processor 1150.

Memory 1154 may include application software embodied in a non-transitory computer readable medium configured to execute as program instructions and/or data on processor 1150. Memory 1154 may include application software configured to execute on processor 1150 to implement a dynamic sticker generator, a messaging application, a messaging user interface, a dynamic keyboard user interface, a dynamic keyboard application, and a dynamic keyboard interface. For example, the dynamic sticker generator 134, the messaging application 140, the messaging user interface 142, the dynamic keyboard user interface 132, the dynamic keyboard application 130, and the dynamic keyboard interface 122 may be implemented as application software accessed by and executed by processor 1150.

Data repository 1152 may store data representing stickers, collections of stickers, edited stickers, sticker packs, recorded stickers, and recents stickers, for example. Data repository 1152 may store image data captured by cameras 1158 and/or 1162, image data from an external data source (e.g., a new sticker data store, and existing sticker data store, or a network). Data repository 1152 may store data representing stickers that have been edited but not saved and may serve as a scratch pad or trash can where deleted or unsaved stickers or image content may be accessed or otherwise retrieved.

In at least some examples, the structures and/or functions of any of the above-described features can be implemented in software, hardware, firmware, circuitry, or a combination thereof Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” or “unit” may refer, for example, to an algorithm or a portion thereof, and/or logic implemented in either hardware circuitry or software, or a combination thereof. These may be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the various purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method, comprising:
detecting an input associated with an image, the input including data associated with one or more attributes of the image;
generating an overlay configured to be at least partially transparent when visually rendered over the image;
producing a file using the one or more attributes, the file including other data associated with the image, the overlay, and formatting and programmatic instructions configured to visually render the image and the overlay when another input is detected; and
detecting the another input associated with placement of a visual rendering of the file and the overlay, the placement being disposed within a display window associated with an application or operating system configured, at least partially, to provide an electronic data communication function between two or more computing devices in data communication with each other in substantially real-time over a distributed data network.

2. The method of claim 1 wherein detecting the input associated with the image comprises:
detecting the input associated with a still image.

3. The method of claim 1 wherein detecting the input associated with the image comprises:
detecting the input associated with an animated image.

4. The method of claim 1 wherein detecting the input associated with the image comprises:
receiving the image responsive to detecting the input as a finger press or a force touch associated with a display of at least one of the two or more computing devices.

5. The method of claim 1 wherein detecting the input associated with the image comprises:
receiving the image responsive to detecting the input as a haptic input or an electronic input.

6. The method of claim 1 wherein generating the overlay comprises:
generating a transparent mask.

7. The method of claim 6 wherein generating the transparent mask comprises:
forming a layer or pixelated image.

8. The method of claim 7 wherein the layer or pixelated image is formed to block, obstruct, or render transparent some, all, or none of light generated as an underlying image in a display of at least one of the two or more computing devices.

9. The method of claim 6 wherein generating the transparent mask comprises:
configuring the transparent mask to render visible appearance of underlying content to an extent of a level of transparency permitted by the transparent mask.

10. A system, comprising:
a display;
a data repository; and
a processor in electrical communication with the display and the data repository, the processor being configured to:
detect an input associated with an image, the input including data associated with one or more attributes of the image;
generate an overlay configured to be at least partially transparent when visually rendered over the image;
produce a file using the one or more attributes, the file including other data associated with the image, the overlay, and formatting and programmatic instructions configured to visually render the image and the overlay when another input is detected; and
detect the another input associated with placement of a visual rendering of the file and the overlay, the placement being disposed within a display window associated with an application or operating system configured, at least partially, to provide an electronic data communication function between two or more computing devices in data communication with each other in substantially real-time over a distributed data network.

11. The system of claim 10 wherein the processor is further configured to:
detect the input associated with a still image.

12. The system of claim 10 wherein the processor is further configured to:
detect the input associated with an animated image.

13. The system of claim 10 wherein the processor is further configured to:
receive the image responsive to detecting the input as a finger press or a force touch associated with a display of at least one of the two or more computing devices.

14. The system of claim 10 wherein the processor is further configured to:
receive the image responsive to detecting the input as a haptic input or an electronic input.

15. The system of claim 10 wherein the processor is further configured to:
generate a transparent mask.

16. The system of claim 15 wherein the processor is further configured to:
form a layer or pixelated image.

17. The system of claim 16 wherein the layer or pixelated image is formed to block, obstruct, or render transparent some, all, or none of light generated as an underlying image in a display of at least one of the two or more computing devices.

18. The system of claim 15 wherein the processor is further configured to:
configure the transparent mask to render visible appearance of underlying content to an extent of a level of transparency permitted by the transparent mask.
